(19) United States
(12) Patent Application Publication
(10) Pub. No.: US 2008/0250019 A1
(43) Pub. Date: Oct. 9, 2008

(54) Method and Device for Recording of Data

(76) Inventor: Nils Zettervall, Lund (SE)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 10/586,564

(22) PCT Filed: Feb. 9, 2005
(86) PCT No.: PCT/SE2005/000160

§ 371 Date: Jun. 20, 2008

(30) Foreign Application Priority Data
Feb. 10, 2004 (SE) 0400265-5

(51) Int. Cl. G06F 17/30

(52) U.S. Cl. 707/8; 707/E17.001

(57) ABSTRACT

A method for recording of data, including the steps of selecting a second set of individuals from a stream of individuals forming a first set of individuals, and providing said second set of individuals with an opportunity to record data on a data collection device (1). The method comprises the step of sequentially producing code carriers comprising a unique code for each code carrier. Individuals are supplied to the second set sequentially by counting the number of individuals coming to the first set. A code carrier is distributed to each individual of the second set of individuals and access to a data collection device is granted by registering the code in the data collection device. Then, data is recorded by inputting into the data collection device, automatic recording of falling off of individuals from the selection by calculating the number of unregistered codes and storing and compiling recorded data.

### TECHNICAL FIELD OF THE INVENTION

A method for recording of data, including the steps of choosing a second set of individuals from a first set of individuals and providing an opportunity to record data. The recorded data may relate to market surveys, personnel surveys, quality analysis and other surveys and investigations.

### STATE OF THE ART

Market surveys and similar are performed both manually and automatically by means of computerized interview consoles. Manual surveys include the use of a questionnaire forming the basis when interviewees are asked questions by an interviewer. After filling in the questionnaire, the subsequent processing can take place manually or by means of computers.

An interview console can comprise a display unit and a keypad, or can be provided with a so called touch screen. An advantage with the use of interview consoles is that questionnaires easily can be modified and adapted to the current situation and previous answers. It is also an advantage that statistics and other forms of test results can be available immediately, due to that all answers are inputted in a computer and are available for data processing.

An important aspect in many types of statistical surveys is to select interviewees correctly, which normally is a random selection. In manual surveys, the personal characteristics and conditions of the interviewer can have an effect on the selection of interviewees. As a consequence thereof the statistical certainty of the survey can be questioned.

Automatic systems of prior art facilitate the management of the survey itself and also the subsequent work but the problem with selecting interviewees from a larger set of individuals in a reliable and statistically correct manner remains. A further disadvantage of prior art systems is that the falling off of selected individuals is not reliably registered.

### SUMMARY OF THE INVENTION

One object of the invention is to eliminate the above mentioned problem and drawback and provide a method for recording of data, which makes it possible to select a correctly defined subset of individuals from a stream of individuals. Any falling off of individuals from said subset will be registered automatically and the effect of the falling off can be considered directly when compiling the information from the recording of data.

The stream of individuals is guided to pass a check point in which the individuals can be counted. Within accidental, but preferably predetermined, intervals an individual is automatically selected as interviewee. The interviewee can be provided with physical evidence, e.g. a code authorizing the interviewee to carry out recording of data on a data recording device. In this context the term recording of data refers to the interviewee answering, through the data recording device, a questionnaire displayed on a display screen or similar.

In connection with the selection, information that an interviewee has been selected is also recorded. Due to the selection being performed automatically and the registration of each interviewee completing an interview also being performed automatically in the data recording device, falling off of selected individuals can be accounted for immediately and can be added to the survey results.

Within the scope of the invention it is also possible to enable selected individuals to accomplish the recording of data immediately in connection with the selection. According to such an embodiment the physical proof and the code carrier can be omitted. The code carrier can also be replaced by biometric information, for example based on face features, retina or finger print, being unique for the selected individual.

According to a first embodiment of the invention counting of individuals in the stream of individuals is performed in connection with the individuals taking a queue number ticket for purchasing a product or service. The number of the queue number ticket, or other information on the queue number ticket, indicates for personnel that the individual has been selected and a code carrier, e.g. a document having a code being unique for each document, is assigned to the individual. According to a second embodiment the selection is performed in connection with the activation of a cash register system or similar due to the payment, or any similar action, by an individual. Within the scope of the invention it is also possible to count individuals passing a counter and, directly with an adjustable interval, provide specific individuals in the stream with a document having information giving the individual access to perform the survey. Also in this case individuals who does not choose to use the access can be counted so that the falling off can be determined.

### BRIEF DESCRIPTION OF THE DRAWINGS

FIG. 1 schematically illustrates a first embodiment according to the invention, wherein individuals are selected immediately and are assigned an access document, and.

FIG. 2 schematically illustrates a second embodiment according to the invention, wherein individuals are selected in connection with payment and then is assigned an access document.

### DESCRIPTION

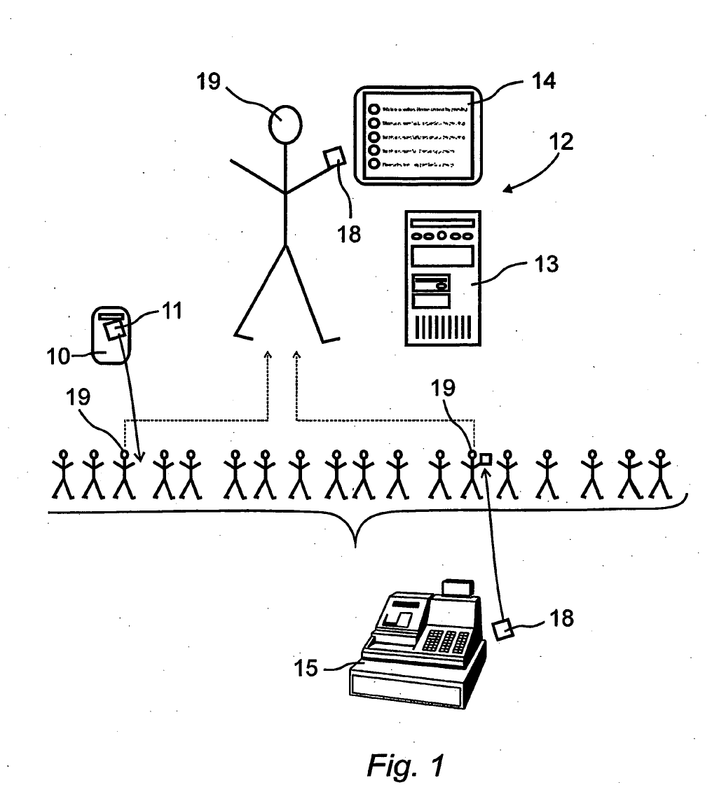

According to the embodiment of FIG. 1 a stream of individuals of a first set of individuals passes by a dispenser 10 for queue number tickets 11. The queue number tickets and the dispenser can be of conventional type but preferably the dispenser 10 is arranged to provide a queue number ticket within an adjustable interval and with specific information. The information can comprise an indication that the individual who received the queue number ticket has been selected for participation in a survey by means of a data collection device 12 and a particular code. The information can also be arranged on specific interspaced queue number tickets in advance. Within the scope of the invention, the interval or interspace between each selection can be predetermined or random. The first selection however is random.

According to this embodiment, the dispenser 10 is also connected to the data collection device 12 and it continuously transfers information about the number of selected individuals to this device. The dispenser 10 comprises a counter counting the number of queue number tickets taken from the dispenser. Due to that each person passing the dispenser 10 is counted by it, the dispenser 10 serves as a passage counter. Generally, in this context passage counters refer to means from which information of the number of selected individuals can be retrieved. Preferably, information about the total number of individuals, or about which portion that has been selected, is also provided.

The specific code is used to give specific selected individuals 19 access rights to activate the data collection device 12 for a session of the survey. The individuals who are selected for participation in the survey are transferred to a second set of individuals. The individuals of the second set are selected within a specific interval, e.g. every tenth individual of the first set is selected and transferred to the second set. The ones included in the second set are assigned a code carrier 18 to be used in connection with the survey.

The data collection device 12 can comprise a computer 13 and a display 14, preferably of the touch screen type. The data collection device 12 is supplemented with keyboard or similar if the display 14 is not a touch screen. Due to that the questionnaire is stored in the data collection device, or in a computer connected to this device, it can easily be changed and by connecting the data collection device with another computer, e.g. through the Internet, remote control can be obtained. An important function of the data collection device 12 is the visual display of the questionnaire.

An alternative to providing the queue number ticket with the specific information is to provide persons arriving at a cash register 15, or similar device, with this information in connection with payment. The cash register can be arranged for automatically printing or feeding out, within a specific interval, a document having corresponding information. It is also possible that the cash register indicates for personnel at the cash register that a document is to be produced manually and be delivered to the person at the cash register.

It should be noted that the document with information required to gain access to activate the data collection device for a survey also can be arranged for automatic reading, so that the interviewee does not have to enter any code. The document serve as a code carrier and can comprise a transponder for electronic reading of a signature or carry an optically readable code. The code carrier can for example be formed as a transponder cooperating with a transmitter and receiver of the data collection device 12.

It is also possible to use other information being specific for the selected person, e.g. information of biometric nature, which in such an embodiment forms the code required for participation in the survey. Equipment for identification by means of retina, face features, fingerprints or corresponding features then cooperates with the data collection device. The equipment can include a video camera, a fingerprint reader or any other biometric sensor.

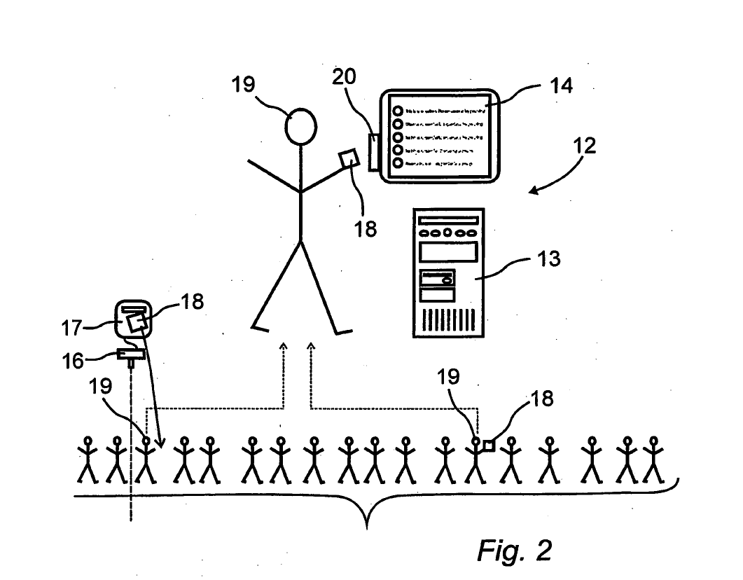

According to an embodiment of the invention illustrated in FIG. 2 a stream of individuals, such as a queue, of a first set of individuals passes by a passage counter 16. The passage counter 16 is connected to or is included in a feeding out device 17 also comprising a dispenser of any type. Within a specific interval, e.g. every tenth individual of the first set passing by, is offered a code carrier 18 from the feeding out device. Thereby the individual is transferred to a second set of individuals. The code carrier 18 is used in a similar manner as described above to provide access to the data collection device 12.

In addition to the code, the code carrier also comprises information indicating that the person who has received the code carrier has been selected as an interviewee. Additionally, information about the procedure and possible rewards for completing the survey should be provided. According to the embodiments including a cash register for administering the code carrier, relevant information about code, interviewee, possible purchase, etc. is suitably transferred to the cash register and a computer connected therewith. By means of this information the survey can be supplemented and correlated with other information.

According to this embodiment the data collection device 12 can also comprise a code reader 20, which can be optic, electronic or arranged for contact independent reading of the code in any other conventional way. The code can also be entered in the data collection device 12 through a conventional keyboard or a so called touch screen.

1. A method for recording of data, including the steps of selecting a second set of individuals from a stream of individuals forming a first set of individuals, and providing said second set of individuals with an opportunity to record data on a data collection device (12), characterised by the steps of sequentially supplying individuals from the stream to the second set by transferring individuals from the first set at selected intervals,
producing a unique code for each individual in the second set of individuals, activating a data collection device by registration of the code,
after activation, switching-over the data collection device for recording of data by an input process,
automatically recording in the data collection device any falling off of individuals from the selection by calculating the number of unregistered codes, and
storing and compiling recorded data in the data collection device.

2. A method according to claim 1, further including the step of transferring individuals from the first set to the second set at random intervals.

3. A method according to claim 1, further including the step of transferring individuals from the first set to the second set at predetermined intervals.

4. A method according to claim 1, further including the step of carrying the code on a code carrier in the form of a queue number ticket having a queue number.

5. A method according to claim 4, also including the step of supplying individuals to the second set depending on the value of the queue number ticket.

6. A method according to claim 1, further including the step of providing a code carrier with an access code for access to the data collection device.

7. A method according to claim 4, also including the step that the code carrier gives an electronically readable mark.

8. A method according to claim 1, also including the step of recording biometric data for each individual in the second set of individuals, wherein the biometric data forms the unique code.

9. A device for recording of data, comprising a data collection device (12) for recording information in connection with a field survey, wherein the data collection device (12) comprises a display (14) and input means, characterised in
that a passage counter (16) is arranged in a passage, through which a stream of individuals forming the first set of individuals passes,
that the passage counter (16) is connected to a feeding out device (17) for feeding out code carriers to a selection of individuals of the first set depending on the number of individuals passing by,
that each code carrier is associated with a unique code,
that the data collection device (12) is adjustable, by registration of the unique code, from a locked mode to an open mode for inputting information,
that the data collection device (12) cooperates with the passage counter (16) and comprises means for counting the number of code carriers being fed out and the number of registered codes, and
that the data collection device (12) is arranged to record answers given on the input means.

10. A device according to claim 9, wherein the passage counter (16) comprises a microwave controlled presence detector.

11. A device according to claim 10, wherein the passage counter (16) comprises an optical detector.

12. A device according to claim 9, wherein the code carrier (18) comprises a readable code.

13. A device according to claim 9, wherein the code carrier (18) comprises a transponder.
